(19) United States
(12) Patent Application Publication
(10) Pub. No.: US 2026/0122397 A1
(43) Pub. Date: Apr. 30, 2026

(54) CLIP-ON EARPHONES

(71) Applicant: SHENZHEN SHOKZ CO., LTD., Shenzhen (CN)

(72) Inventors: Lei ZHONG, Shenzhen (CN); Haochen LIU, Shenzhen (CN); Shiyu YU, Shenzhen (CN); Chaojie CUI, Shenzhen (CN); Jiang XU, Shenzhen (CN); Tao ZHAO, Shenzhen (CN); Xiaoyu MA, Shenzhen (CN); Ao JI, Shenzhen (CN); Sitan CHEN, Shenzhen (CN)

(73) Assignee: SHENZHEN SHOKZ CO., LTD., Shenzhen (CN)

(21) Appl. No.: 19/433,195

(22) Filed: Dec. 26, 2025

Related U.S. Application Data
(63) Continuation of application No. PCT/CN2025/071909, filed on Jan. 10, 2025.

(30) Foreign Application Priority Data
Dec. 11, 2023 (CN) 202311701969.7
Feb. 6, 2024 (WO) PCT/CN2024/076495

(51) Int. Cl. H04R 1/10

(52) U.S. Cl. CPC H04R 1/105; H04R 1/1016

(57) ABSTRACT

A clip-on earphone is provided, including a sound production portion, an abutment portion, and an ear hook connecting the sound production portion and the abutment portion. The ear hook has an ear hook symmetry plane along a length direction thereof, when the clip-on earphone is in a natural state, on the ear hook symmetry plane, the clip-on earphone has a reference tangent, a contour line of the sound production portion and a contour line of the abutment portion are respectively tangent to the reference tangent. The contour line of the sound production portion and the contour line of the abutment portion are located on a same side of the reference tangent. An inner contour line of the ear hook has a first reference point farthest from the reference tangent, and a reference perpendicular drawn from the first reference point to the reference tangent passes through the abutment portion.

### CROSS-REFERENCE TO RELATED APPLICATIONS

This application is a continuation of International Application No. PCT/CN2025/071909 filed on Jan. 10, 2025, which claims priority to Chinese Patent Application No. 202311701969.7 filed on Dec. 11, 2023 and International Application No. PCT/CN2024/076495 filed on Feb. 6, 2024, the entire contents of each of which are hereby incorporated by reference.

### TECHNICAL FIELD

The present disclosure relates to a technical field of electronic devices, and in particular, to a clip-on earphone.

### BACKGROUND

Earphones have been widely used in daily life. The earphones can be used in conjunction with electronic devices such as mobile phones and computers to provide sound playback functionality for a user. A clip-on earphone is a new type of earphone, which is usually small in size and can be clipped onto an ear of a wearer for use, thus being favored by the user. How to improve wearing comfort of the clip-on earphone has become a widely studied technical problem.

### SUMMARY

One or more embodiments of the present disclosure provide a clip-on earphone, comprising: a sound production portion for inserting into a concha cavity of a wearer; an abutment portion for abutting against a back of an ear of the wearer; and an ear hook connecting the sound production portion and the abutment portion, wherein the ear hook has an ear hook symmetry plane along a length direction thereof, wherein when the clip-on earphone is in a natural state, on the ear hook symmetry plane, the clip-on earphone has a reference tangent, a contour line of the sound production portion and a contour line of the abutment portion are respectively tangent to the reference tangent, and the contour line of the sound production portion and the contour line of the abutment portion are located on a same side of the reference tangent; and an inner contour line of the ear hook has a first reference point farthest from the reference tangent, a reference perpendicular is drawn from the first reference point to the reference tangent, and the reference perpendicular passes through the abutment portion.

In some embodiments, when the clip-on earphone is in the natural state, on the ear hook symmetry plane, the contour line of the abutment portion has a second reference point closest to the sound production portion, and a distance between the second reference point and the reference perpendicular is 2-8 mm.

In some embodiments, a connecting line between the second reference point and the first reference point is denoted as a first reference line. When the clip-on earphone is in the natural state, on the ear hook symmetry plane, the inner contour line of the ear hook has a third reference point farthest from the second reference point, a connecting line between the second reference point and the third reference point is denoted as a second reference line, and the second reference line is located on a side of the first reference line closer to the abutment portion.

In some embodiments, when the clip-on earphone is in the natural state, an angle between the first reference line and the second reference line is 8°-25°.

In some embodiments, when the clip-on earphone is in the natural state, an angle between the first reference line and the reference tangent is 50°-85°.

In some embodiments, when the clip-on earphone is in the natural state, a length of the second reference line is 13-20 mm.

In some embodiments, when the clip-on earphone is in the natural state, on the ear hook symmetry plane, the reference perpendicular has a first side and a second side arranged opposite to each other, and the sound production portion is located on the first side of the reference perpendicular; and on the first side of the reference perpendicular, an inner contour line of the clip-on earphone has a fourth reference point farthest from the reference perpendicular, a distance between the fourth reference point and the reference perpendicular is denoted as a first distance, and the first distance is 4-9 mm.

In some embodiments, when the clip-on earphone is in the natural state, on the second side of the reference perpendicular, the inner contour line of the clip-on earphone has a fifth reference point farthest from the reference perpendicular, a distance between the fifth reference point and the reference perpendicular is denoted as a second distance, and the second distance is 7-13 mm.

In some embodiments, when the clip-on earphone is in the natural state, on the ear hook symmetry plane, an arc-to-chord ratio of the inner contour line of the clip-on earphone between the first reference point and the fourth reference point is 1.08-1.20, and an arc-to-chord ratio of the inner contour line of the clip-on earphone between the first reference point and the fifth reference point is 1.01-1.06.

In some embodiments, when the clip-on earphone is in the natural state, on the ear hook symmetry plane, the contour line of the abutment portion has a sixth reference point closest to the first reference point, and a length of a connecting line between the first reference point and the sixth reference point is 6-10 mm.

In some embodiments, when the clip-on earphone is in the natural state, on the ear hook symmetry plane, an arc-to-chord ratio of the inner contour line of the clip-on earphone between the first reference point and the sixth reference point is 1.7-2.2.

In some embodiments, the ear hook and the sound production portion are configured as two separate components, and a parting line exists at an assembly position therebetween; and an outer contour line of the clip-on earphone has a seventh reference point farthest from the reference tangent, and the seventh reference point is located on the ear hook.

In some embodiments, each section of the ear hook comprises a support rib and a flexible body wrapping the support rib or each section of the ear hook has elasticity; and the outer contour line of the clip-on earphone has a seventh reference point farthest from the reference tangent, and the seventh reference point is located on the ear hook.

In some embodiments, when the clip-on earphone is in the natural state, on the ear hook symmetry plane, an angle between a connecting line of two opposite ends of the ear hook and the reference tangent is less than or equal to 45°.

In some embodiments of the present disclosure, when a length of an ear hook 13 is fixed, by arranging a reference perpendicular L2 to pass through an abutment portion 12, that is, the reference perpendicular L2 is offset toward a side where the abutment portion 12 is located, an inner contour of the ear hook 13 can conform to a shape of the ear while avoiding the helix E17, thereby improving wearing comfort.

### BRIEF DESCRIPTION OF THE DRAWINGS

In order to more clearly illustrate the technical solutions in the embodiments of the present disclosure, the drawings used in the description of the embodiments will be briefly introduced below. It is obvious that the drawings in the following description are only some embodiments of the present disclosure. Those skilled in the art, without further creative efforts, may apply the present disclosure to other similar scenarios according to these drawings, and wherein:

FIG. 1 is a schematic diagram illustrating a clip-on earphone according to an embodiment of the present disclosure in a wearing state;

FIG. 2 is a cross-sectional schematic diagram illustrating the clip-on earphone shown in FIG. 1 along an ear hook symmetry plane when the clip-on earphone is in a natural state;

FIG. 3 is a cross-sectional schematic diagram illustrating a clip-on earphone according to another embodiment of the present disclosure along an ear hook symmetry plane when the clip-on earphone is in a natural state;

FIG. 4 is another schematic diagram illustrating the clip-on earphone shown in FIG. 1 in a wearing state; and

FIG. 5 is a three-dimensional schematic diagram illustrating a clip-on earphone according to another embodiment of the present disclosure in a natural state.

### DETAILED DESCRIPTION

To more clearly illustrate the technical solutions in the embodiments of the present disclosure, the drawings used in the description of the embodiments will be briefly introduced below. It should be understood that the purposes of these illustrated embodiments are only provided to those skilled in the art to practice the application, and not intended to limit the scope of the present disclosure. It should also be noted that, for ease of description, only parts related to the present disclosure, rather than the entire structure, are shown in the drawings. Based on the embodiments of the present disclosure, all other embodiments obtained by those skilled in the art without creative efforts fall within the scope of protection of the present disclosure.

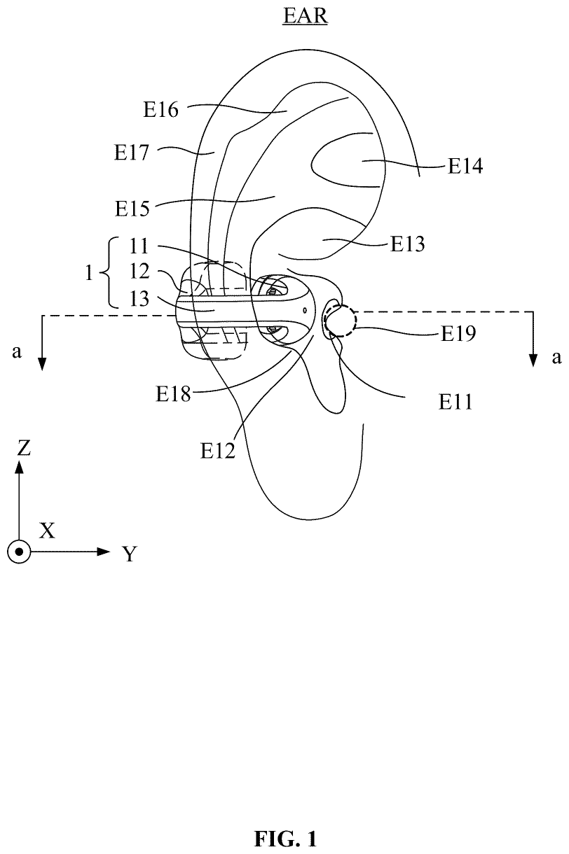

As shown in FIG. 1, FIG. 1 is a schematic diagram illustrating a clip-on earphone according to an embodiment of the present disclosure in a wearing state. An ear EAR of a user may include physiological parts such as an external auditory canal E11, a concha cavity E12, a cymba conchae E13, a triangular fossa E14, an antihelix E15, a scapha E16, a helix E17, and an antitragus E18. Although the external auditory canal E11 has a certain depth and extends to a tympanic membrane of the ear, for ease of illustration, an ear canal may be understood as the external auditory canal E11. The physiological parts such as the concha cavity E12, the cymba conchae E13, and the triangular fossa E14 have a certain volume and depth. The concha cavity E12 is directly connected to the external auditory canal E11, that is, the external auditory canal E11 may simply be considered to be located at a bottom of the concha cavity E12. Further, a periphery of the external auditory canal E11 also includes a tragus E19, and the tragus E19 is convex.

In addition, in fields such as medicine and anatomy, three basic planes (i.e., a sagittal plane, a coronal plane, and a horizontal plane) and three basic axes (i.e., a sagittal axis, a coronal axis, and a vertical axis) may be defined for a human body. The sagittal plane refers to a plane that is made along an anteroposterior direction of the body and is perpendicular to the ground, and the sagittal plane divides the human body into a left part and a right part. The coronal plane refers to a plane that is made along a left-right direction of the body and is perpendicular to the ground, and the coronal plane divides the human body into a front part and a rear part. The horizontal plane refers to a plane that is made along an up-down direction of the body and is parallel to the ground, and the horizontal plane divides the human body into an upper part and a lower part. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the up-down direction of the body and perpendicular to the horizontal plane. By observing the ear EAR along a direction of the coronal axis of the human body, a schematic diagram illustrating a clip-on earphone 1 in a wearing state as shown in FIG. 1 may be obtained. In FIG. 1, three directions X, Y, and Z may be simply regarded as the coronal axis, the sagittal axis, and the vertical axis of the human body, respectively. Three planes XY, XZ, and YZ may be simply regarded as the horizontal plane, the coronal plane, and the sagittal plane of the human body, respectively.

Referring further to FIG. 1, the clip-on earphone 1 includes a sound production portion 11 for inserting into the concha cavity E12 of a wearer, an abutment portion 12 for abutting against a back of an ear of the wearer, and an ear hook 13 connecting the sound production portion 11 and the abutment portion 12. The sound production portion 11 may serve as a sound playback device, which is configured to convert an electrical signal into a sound signal and play the sound signal to the wearer. The abutment portion 12 may serve as a battery compartment for installing a battery or other components. The abutment portion 12 and the sound production portion 11 form a clamping state to clamp and wear the entire earphone on the helix E17 of the wearer. Specifically, the sound production portion 11 may abut against an inner wall of the concha cavity E12, and the abutment portion 12 may abut against the back of the ear, so that the clip-on earphone 1 bypasses the helix E17 to be clamped and worn on the ear of the wearer. In some embodiments, the abutment portion 12 may not serve as the battery compartment, and the battery may be installed in the sound production portion 11.

The ear hook 13 has an ear hook symmetry plane a-a arranged along a length direction thereof. Specifically, the ear hook symmetry plane a-a refers to a plane where the ear hook 13 is bilaterally symmetric along the length direction thereof. When the ear hook 13 has an irregular asymmetric structure, a difference of the ear hook 13 on both sides of the ear hook symmetry plane a-a should be the smallest among various division manners.

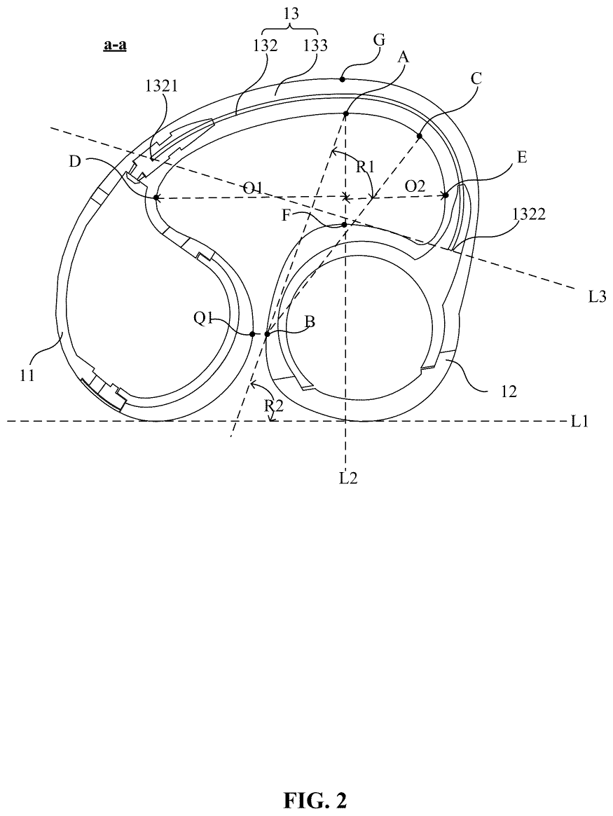

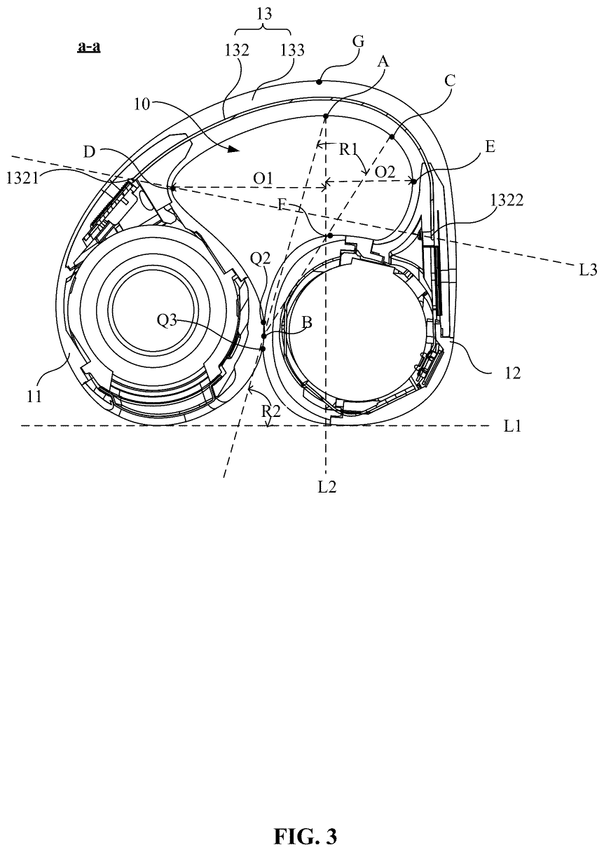

As shown in FIG. 2 and FIG. 3, FIG. 2 is a cross-sectional schematic diagram illustrating the clip-on earphone shown in FIG. 1 along an ear hook symmetry plane when the clip-on earphone is in a natural state. FIG. 3 is a cross-sectional schematic diagram illustrating a clip-on earphone according to another embodiment of the present disclosure along an ear hook symmetry plane when the clip-on earphone is in a natural state. When the clip-on earphone 1 is in the natural state, on the ear hook symmetry plane a-a, the clip-on earphone 1 has a reference tangent L1. A contour line of the sound production portion 11 and a contour line of the abutment portion 12 are respectively tangent to the reference tangent L1, and the contour line of the sound production portion 11 and the contour line of the abutment portion 12 are located on a same side of the reference tangent L1. An inner contour line of the ear hook 13 has a first reference point A farthest from the reference tangent L1. A reference perpendicular L2 is drawn from the first reference point A to the reference tangent L1, and the reference perpendicular L2 passes through the abutment portion 12.

The natural state described in the present disclosure refers to a state in which the clip-on earphone 1 is not subjected to an external force is applied. The “wearing state” described in the present disclosure refers to a state in which the clip-on earphone 1 is clamped and worn on an ear of a wearer. The contour line of the sound production portion 11 refers to a contour line of a cross-section formed by the sound production portion 11 on the ear hook symmetry plane a-a. The contour line of the abutment portion 12 refers to a contour line of a cross-section formed by the abutment portion 12 on the ear hook symmetry plane a-a. An inner contour of the ear hook 13 refers to a contour of a side of the ear hook 13 close to the ear in the wearing state. The inner contour line of the ear hook 13 may refer to a contour line formed by the inner contour of the ear hook 13 on the ear hook symmetry plane a-a. It should be noted that a “contour line,” an “inner contour line,” and an “outer contour line” of a portion or a whole of the earphone mentioned in the present disclosure all refer to a contour line of a cross-section formed by the portion or the whole of the earphone on the ear hook symmetry plane a-a.

In some embodiments of the present disclosure, when a length of the ear hook 13 is fixed, by arranging the reference perpendicular L2 to pass through the abutment portion 12 (i.e., the reference perpendicular L2 is offset toward a side where the abutment portion 12 is located), the inner contour of the ear hook 13 can conform to a shape of the ear while avoiding the helix E17, thereby improving wearing comfort.

As shown in FIG. 1, in some embodiments, an overall shape of the sound production portion 11 may be approximately spherical, a shape of the abutment portion 12 may be approximately cylindrical, and the ear hook 13 is connected between the abutment portion 12 and the sound production portion 11. When the clip-on earphone 1 is in the natural state, the sound production portion 11 and the abutment portion 12 may be arranged at an interval. Correspondingly, as shown in FIG. 2, when the clip-on earphone 1 is in the natural state, on the ear hook symmetry plane a-a, the sound production portion 11 and the abutment portion 12 are arranged at an interval.

In some embodiments, when the clip-on earphone 1 is in the natural state, the sound production portion 11 and the abutment portion 12 may abut against each other. Correspondingly, as shown in FIG. 3, when the clip-on earphone 1 is in the natural state, on the ear hook symmetry plane a-a, the sound production portion 11 and the abutment portion 12 are at least partially in contact.

As shown in FIG. 2 and FIG. 3, in some embodiments, when the clip-on earphone 1 is in the natural state, on the ear hook symmetry plane a-a, the contour line of the abutment portion 12 has a second reference point B closest to the sound production portion 11. A distance between the second reference point B and the reference perpendicular L2 is 2-8 mm. For example, the distance between the second reference point B and the reference perpendicular L2 may be 2 mm, 3 mm, 4 mm, 5 mm, 6 mm, 7 mm, or 8 mm.

As shown in FIG. 2, in the natural state, when the sound production portion 11 and the abutment portion 12 are spaced apart from each other, the second reference point B may refer to an endpoint B of a shortest connecting line Q1B between the sound production portion 11 and the abutment portion 12 on the ear hook symmetry plane a-a, where the endpoint B is located on the contour line of the abutment portion 12 and an endpoint Q1 is located on the contour line of the sound production portion 11.

As shown in FIG. 3, in the natural state, when the sound production portion 11 and the abutment portion 12 abut against each other, the second reference point B may refer to a midpoint of an arc line Q2Q3 formed by an abutting area between the sound production portion 11 and the abutment portion 12 on the ear hook symmetry plane a-a.

In some embodiments of the present disclosure, by further setting the distance between the second reference point B and the reference perpendicular L2 to 2-8 mm, an offset of the reference perpendicular L2 toward the side where the abutment portion 12 is located is controlled within a reasonable range, so that the inner contour of the ear hook 13 can be better conform to the shape of the ear and avoid the helix E17, which is conducive to further improving wearing comfort.

As shown in FIG. 2 and FIG. 3, in some embodiments, a connecting line between the second reference point B and the first reference point A is denoted as a first reference line BA. When the clip-on earphone 1 is in the natural state, on the ear hook symmetry plane a-a, the inner contour line of the ear hook 13 has a third reference point C farthest from the second reference point B. A connecting line between the second reference point B and the third reference point C is denoted as a second reference line BC. The second reference line BC is located on a side of the first reference line BA close to the abutment portion 12.

In some embodiments of the present disclosure, by arranging the second reference line BC on the side of the first reference line BA close to the abutment portion 12, when the length of the ear hook 13 is fixed, the inner contour of the ear hook 13 as a whole is offset toward the side where the abutment portion 12 is located, which can be better conform to the shape of the ear and avoid the helix E17, thereby further improving wearing comfort.

As shown in FIG. 2 and FIG. 3, in some embodiments, when the clip-on earphone 1 is in the natural state, an angle R1 between the first reference line BA and the second reference line BC is 8°-25°. For example, the angle R1 between the first reference line BA and the second reference line BC may be 8°, 11°, 13°, 15°, 18°, 20°, or 25°.

In some embodiments of the present disclosure, by further setting the angle R1 between the first reference line BA and the second reference line BC to 8°-25°, an offset of the inner contour of the ear hook 13 toward the side where the abutment portion 12 is located is controlled within a reasonable range, which can be better conform to the shape of the ear and avoid the helix E17, thereby further improving wearing comfort.

As shown in FIG. 2 and FIG. 3, in some embodiments, when the clip-on earphone 1 is in the natural state, an angle R2 between the first reference line BA and the reference tangent L1 is 50°-85°. For example, the angle R2 between the first reference line BA and the reference tangent L1 may be 50°, 60°, 65°, 70°, 75°, 80°, or 85°.

In some embodiments of the present disclosure, by further setting the angle R2 between the first reference line BA and the reference tangent L1 to 50°-85°, the offset of the inner contour of the ear hook 13 toward the side where the abutment portion 12 is located is controlled within a reasonable range, which can be better conform to the shape of the ear and avoid the helix E17, thereby further improving wearing comfort.

As shown in FIG. 2 and FIG. 3, in some embodiments, when the clip-on earphone 1 is in the natural state, a length of the second reference line BC is 13-20 mm. For example, the length of the second reference line BC may be 13 mm, 14 mm, 15 mm, 16 mm, 17 mm, 18 mm, 19 mm, or 20 mm.

In some embodiments of the present disclosure, by arranging the second reference line BC on a side of the first reference line BA close to the abutment portion 12, setting the angle between the first reference line BA and the second reference line BC to 8°-25°, setting the angle between the first reference line BA and the reference tangent L1 to 50°-85°, and further setting the length of the second reference line BC to 13-20 mm, on one hand, the offset of the inner contour of the ear hook 13 toward the side where the abutment portion 12 is located is controlled within a reasonable range, which can be better conform to the shape of the ear and avoid the helix E17, thereby further improving wearing comfort; on the other hand, the sound production portion 11 and the abutment portion 12 can be stably clamped on the ear under an action of the ear hook 13, which is conducive to improving wearing stability.

As shown in FIG. 2 and FIG. 3, in some embodiments, when the clip-on earphone 1 is in the natural state, on the ear hook symmetry plane a-a, the reference perpendicular L2 has a first side and a second side arranged opposite to each other. The sound production portion 11 is located on the first side of the reference perpendicular L2. On the first side of the reference perpendicular L2, an inner contour line of the clip-on earphone 1 has a fourth reference point D farthest from the reference perpendicular L2. A distance between the fourth reference point D and the reference perpendicular L2 is denoted as a first distance O1. The first distance O1 is 4-9 mm. For example, the first distance O1 may be 4 mm, 5 mm, 6 mm, 7 mm, 8 mm, or 9 mm.

In some embodiments, an inner contour of the clip-on earphone 1 may refer to a contour of a side of the clip-on earphone 1 close to the ear in a wearing state. The inner contour line of the clip-on earphone 1 may refer to a contour line formed by the inner contour of the clip-on earphone 1 on the ear hook symmetry plane a-a. An outer contour of the clip-on earphone 1 may refer to a contour of a side of the clip-on earphone 1 away from the ear in the wearing state. An outer contour line of the clip-on earphone 1 may refer to a contour line formed by the outer contour of the clip-on earphone 1 on the ear hook symmetry plane a-a.

As shown in FIG. 2, when the clip-on earphone 1 is in the natural state, if the sound production portion 11 and the abutment portion 12 are spaced apart from each other, the inner contour line and the outer contour line of the clip-on earphone 1 may be defined by two endpoints Q1 and B of the shortest connecting line Q1B between the sound production portion 11 and the abutment portion 12. The two endpoints Q1 and B divide an entire contour of the clip-on earphone 1 into two segments of which the one closer to the ear in the wearing state is the inner contour line.

As shown in FIG. 3, when the clip-on earphone 1 is in the natural state, the sound production portion 11 and the abutment portion 12 abut against each other, the sound production portion 11, the abutment portion 12, and the ear hook 13 together enclose a closed space 10. The inner contour line of the clip-on earphone 1 may refer to a contour line enclosing the closed space 10. A remaining contour line of the clip-on earphone 1 may be understood as the outer contour line.

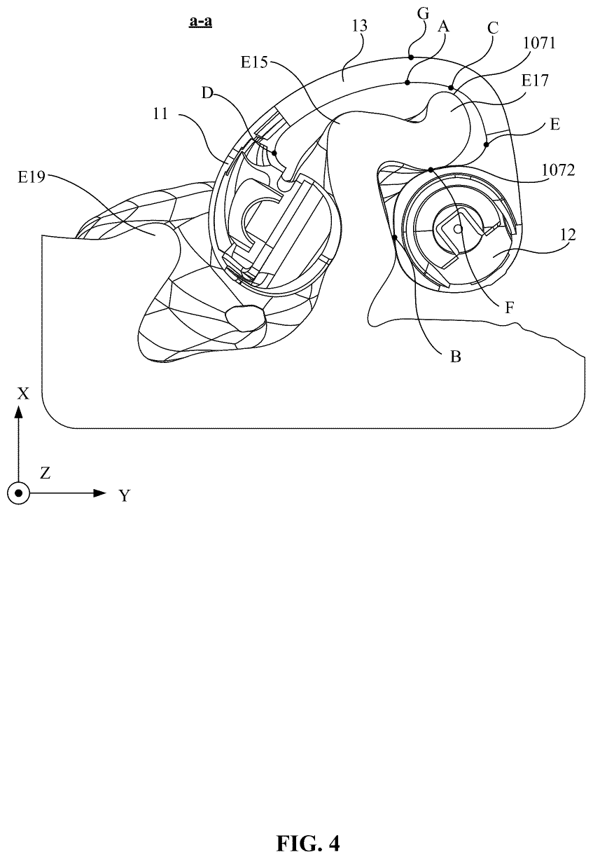

Referring to FIG. 2 and FIG. 4, FIG. 4 is another schematic diagram illustrating the clip-on earphone shown in FIG. 1 in a wearing state. If the first distance O1 is too small, it may result in that the inner contour of the clip-on earphone 1 comes into contact with the helix E17, which easily squeezes the helix E17 and results in poor wearing comfort. If the first distance O1 is too large, it may result in that an overall size of the clip-on earphone 1 increases, leading to an increase in an overall mass and a shift in a center of gravity of the clip-on earphone 1, thereby reducing wearing stability.

In some embodiments of the present disclosure, by setting the first distance O1 to 4-9 mm, the inner contour of the clip-on earphone 1 can bypass the helix E17 as much as possible, avoiding squeezing the helix E17, while also controlling the overall size of the clip-on earphone 1 within a certain range, thereby improving wearing comfort and wearing stability of the clip-on earphone 1.

As shown in FIG. 2 and FIG. 3, in some embodiments, when the clip-on earphone 1 is in the natural state, on the second side of the reference perpendicular L2, the inner contour line of the clip-on earphone 1 has a fifth reference point E farthest from the reference perpendicular L2. A distance between the fifth reference point E and the reference perpendicular L2 is denoted as a second distance O2. The second distance O2 is 7-13 mm. For example, the second distance O2 may be 7 mm, 8 mm, 9 mm, 10 mm, 11 mm, 12 mm, or 13 mm.

Referring to FIG. 2 and FIG. 4, if the second distance O2 is too small, it may result in that the inner contour of the clip-on earphone 1 comes into contact with the antihelix E15, which easily squeezes the antihelix E15 and results in poor wearing comfort. If the second distance O2 is too large, it may result in that the overall size of the clip-on earphone 1 increases, leading to an increase in the overall mass of the clip-on earphone 1 and reducing wearing stability.

In some embodiments of the present disclosure, by setting the second distance O2 to 7-13 mm, the inner contour of the clip-on earphone 1 can bypass the antihelix E15 as much as possible, avoiding squeezing the antihelix E15, while also controlling the overall size of the clip-on earphone 1 within a certain range, thereby improving wearing comfort and wearing stability of the clip-on earphone 1.

As shown in FIG. 2 and FIG. 3, in some embodiments, when the clip-on earphone 1 is in the natural state, on the ear hook symmetry plane a-a, an arc-to-chord ratio of the inner contour line of the clip-on earphone 1 between the first reference point A and the fourth reference point D is 1.08-1.20. For example, the arc-to-chord ratio of the inner contour line of the clip-on earphone 1 between the first reference point A and the fourth reference point D may be 1.08, 1.10, 1.12, 1.14, 1.16, 1.18, or 1.20. An arc-to-chord ratio of the inner contour line of the clip-on earphone 1 between the first reference point A and the fifth reference point E is 1.01-1.06. For example, the arc-to-chord ratio of the inner contour line of the clip-on earphone 1 between the first reference point A and the fifth reference point E may be 1.01, 1.02, 1.03, 1.04, 1.05, or 1.06.

In some embodiments of the present disclosure, by setting the first distance O1 to 4-9 mm, setting the second distance O2 to 7-13 mm, and further setting the arc-to-chord ratio of the inner contour line of the clip-on earphone 1 between the first reference point A and the fourth reference point D to 1.08-1.20, and setting the arc-to-chord ratio of the inner contour line of the clip-on earphone 1 between the first reference point A and the fifth reference point E to 1.01-1.06, the earphone can better conform to the shape of the ear and avoid the helix E17 and the antihelix E15, thereby improving wearing comfort.

As shown in FIG. 2 and FIG. 3, in some embodiments, when the clip-on earphone 1 is in the natural state, on the ear hook symmetry plane a-a, the contour line of the abutment portion 12 has a sixth reference point F closest to the first reference point A. A length of a connecting line AF between the first reference point A and the sixth reference point F is 6-10 mm. For example, the length of the connecting line AF may be 6 mm, 7 mm, 8 mm, 9 mm, or 10 mm.

If the length of the connecting line AF is too small, it may result in that the inner contour of the ear hook 13 comes into contact with an edge 1071 of the helix E17 in the wearing state, and/or the abutment portion 12 comes into contact with a rear side 1072 of the helix E17, which easily squeezes the helix E17. If the length of the connecting line AF is too large, it may result in that the overall size of the clip-on earphone 1 increases, leading to an increase in the overall mass of the clip-on earphone 1 and reducing wearing stability.

By setting the length of the connecting line AF to 6-10 mm, the present disclosure enables the inner contour of the ear hook 13 to bypass the antihelix E17 as much as possible, avoiding squeezing the antihelix E17, while also controlling the overall size of the clip-on earphone 1 within a certain range, thereby improving wearing comfort and wearing stability of the clip-on earphone 1.

As shown in FIG. 2, in some embodiments, when the clip-on earphone 1 is in the natural state, on the ear hook symmetry plane a-a, an arc-to-chord ratio of the inner contour line of the clip-on earphone 1 between the first reference point A and the sixth reference point F is 1.7-2.2. For example, the arc-to-chord ratio of the inner contour line of the clip-on earphone 1 between the first reference point A and the sixth reference point F may be 1.7, 1.8, 1.9, 2.0, 2.1, or 2.2.

If the arc-to-chord ratio of the inner contour line of the clip-on earphone 1 between the first reference point A and the sixth reference point F is too small, it may result in that the inner contour of the clip-on earphone 1 comes into contact with the helix E17, which easily squeezes the helix E17 and results in poor wearing comfort. If the arc-to-chord ratio of the inner contour line of the clip-on earphone 1 between the first reference point A and the sixth reference point F is too large, it may result in that the overall size of the clip-on earphone 1 increases, leading to an increase in the overall mass of the clip-on earphone 1 and reducing wearing stability.

In some embodiments of the present disclosure, by setting the arc-to-chord ratio of the inner contour line of the clip-on earphone 1 between the first reference point A and the sixth reference point F within a range of 1.7-2.2, the inner contour of the clip-on earphone 1 can better bypass the helix E17, avoiding squeezing the helix E17, while also controlling the overall size of the clip-on earphone 1 within a certain range, thereby improving wearing comfort and wearing stability of the clip-on earphone 1.

As shown in FIG. 2 and FIG. 3, in some embodiments, the ear hook 13 includes a support rib 132 and a flexible body 133 wrapping the support rib 132. The support rib 132 is an elastic metal sheet or an elastic metal wire, and includes a first end 1321 and a second end 1322 arranged opposite each other. The first end 1321 of the support rib 132 is connected to the sound production portion 11. The second end 1322 of the support rib 132 is connected to the abutment portion 12. In this situation, a position of the first end 1321 of the support rib 132 may be understood as a boundary between the ear hook 13 and the sound production portion 11. A position of the second end 1322 of the support rib 132 may be understood as a boundary between the ear hook 13 and the abutment portion 12. That is, it can be understood that each section of the ear hook 13 includes the support rib 132 and the flexible body 133 wrapping the support rib 132, thereby determining the boundary between the ear hook 13 and the sound production portion 11 or the abutment portion 12.

In some embodiments, the ear hook 13 may not include both the support rib 132 and the flexible body 133, but still has a certain elasticity. For example, the sound production portion 11 includes a plastic housing with a certain strength to protect components arranged inside. The ear hook 13 has elasticity and may be deformed to provide a clamping force, ensuring stability in the wearing state. In this situation, a portion capable of elastic deformation may be understood as the ear hook 13, and a portion incapable of elastic deformation may be understood as the sound production portion 11 or the abutment portion 12. That is, it can be understood that each section of the ear hook 13 has elasticity, thereby determining the boundary between the ear hook 13 and the sound production portion 11 or the abutment portion 12.

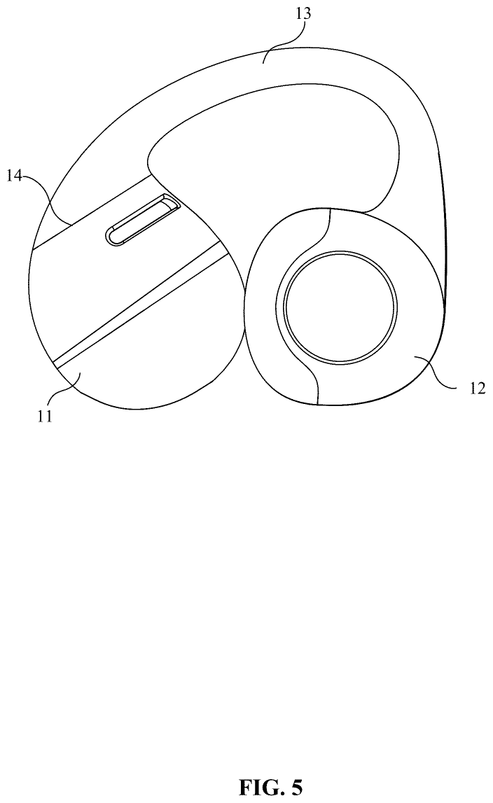

As shown in FIG. 5, FIG. 5 is a three-dimensional schematic diagram illustrating a clip-on earphone according to another embodiment of the present disclosure in a natural state. In some embodiments, the ear hook 13 and the sound production portion 11 are configured as two separate components. There is a first parting line 14 at an assembly position between the ear hook 13 and the sound production portion 11. In this situation, a position of the first parting line 14 may be understood as the boundary between the ear hook 13 and the sound production portion 11.

In some embodiments, the ear hook 13 and the abutment portion 12 are provided as two separate components. There is a second parting line at an assembly position between the ear hook 13 and the abutment portion 12. In this situation, a position of the second parting line may be understood as the boundary between the ear hook 13 and the abutment portion 12.

As shown in FIG. 2 and FIG. 3, the outer contour line of the clip-on earphone 1 has a seventh reference point G farthest from the reference tangent L1. The seventh reference point G is located on the ear hook 13. In some embodiments of the present disclosure, by arranging the seventh reference point G on the ear hook 13, it is beneficial to control the overall size of the clip-on earphone 1, thereby improving wearing stability.

As shown in FIG. 2 and FIG. 3, in some embodiments, when the clip-on earphone 1 is in the natural state, on the ear hook symmetry plane a-a, an angle between a connecting line L3 between two opposite ends of the ear hook 13 and the reference tangent L1 is less than or equal to 45°. For example, the angle between the connecting line L3 between two opposite ends of the ear hook 13 and the reference tangent L1 may be 10°, 20°, 30°, 40°, or 45°.

In some embodiments of the present disclosure, by setting the angle between the connecting line L3 between two opposite ends of the ear hook 13 and the reference tangent L1 to be less than or equal to 45°, the inner contour of the ear hook 13 can better conform to the shape of the ear, thereby further improving wearing comfort.

In the above description of the present disclosure, unless otherwise clearly specified and limited, terms such as “fixed,” “mounted,” “connected,” or “coupled” should be interpreted broadly. For example, the term “connected” may refer to a fixed connection, a detachable connection, or an integral connection. The term “connected” may refer to a mechanical connection or an electrical connection. The term “connected” may refer to a direct connection, or an indirect connection through an intermediate medium, or an internal communication between two components or an interaction relationship between two components. Therefore, unless otherwise clearly limited in the present disclosure, those skilled in the art can understand the specific meanings of the above terms in the present disclosure according to specific situations.

Based on the above description of the present disclosure, those skilled in the art can also understand the terms used below. For example, terms indicating orientation or positional relationship such as “upper,” “lower,” “front,” “rear,” “left,” “right,” “length,” “width,” “thickness,” “vertical,” “horizontal,” “top,” “bottom,” “inner,” “outer,” “axial,” “radial,” “circumferential,” “central,” “longitudinal,” “transverse,” “clockwise,” or “counterclockwise” are based on the orientation or positional relationship shown in the drawings of the present disclosure. These terms are only for the purpose of facilitating the description of the solution of the present disclosure and simplifying the description, and do not indicate or imply that the device or component involved must have the specific orientation, be constructed and operated in a specific orientation. Therefore, the above orientation or positional relationship terms cannot be understood or interpreted as limitations on the solution of the present disclosure. In addition, the terms “first” or “second” used in the present disclosure to refer to numbers or sequence numbers are for descriptive purposes only and should not be understood as indicating relative importance or implicitly indicating the number of the indicated technical features. Thus, features defined with “first” or “second” may explicitly or implicitly include at least one such feature. In the description of the present disclosure, the meaning of “a plurality of” is at least two, such as two, three, or more, unless otherwise clearly and specifically limited.

The above descriptions are only embodiments of the present disclosure and are not intended to limit the patent scope of the present disclosure. Any equivalent structure or equivalent process transformation made based on the content of the specification and drawings of the present disclosure, or directly or indirectly applied in other related technical fields, shall similarly be included within the patent protection scope of the present disclosure.

1. A clip-on earphone, comprising:
a sound production portion for inserting into a concha cavity of a wearer;
an abutment portion for abutting against a back of an ear of the wearer; and
an ear hook connecting the sound production portion and the abutment portion, wherein the ear hook has an ear hook symmetry plane along a length direction thereof, wherein
when the clip-on earphone is in a natural state, on the ear hook symmetry plane, the clip-on earphone has a reference tangent, a contour line of the sound production portion and a contour line of the abutment portion are respectively tangent to the reference tangent, and the contour line of the sound production portion and the contour line of the abutment portion are located on a same side of the reference tangent; and
an inner contour line of the ear hook has a first reference point farthest from the reference tangent, a reference perpendicular is drawn from the first reference point to the reference tangent, and the reference perpendicular passes through the abutment portion.

2. The clip-on earphone of claim 1, wherein
when the clip-on earphone is in the natural state, on the ear hook symmetry plane, the contour line of the abutment portion has a second reference point closest to the sound production portion, and a distance between the second reference point and the reference perpendicular is 2-8 mm.

3. The clip-on earphone of claim 2, wherein
a connecting line between the second reference point and the first reference point is denoted as a first reference line;
when the clip-on earphone is in the natural state, on the ear hook symmetry plane, the inner contour line of the ear hook has a third reference point farthest from the second reference point, a connecting line between the second reference point and the third reference point is denoted as a second reference line, and the second reference line is located on a side of the first reference line closer to the abutment portion.

4. The clip-on earphone of claim 3, wherein
when the clip-on earphone is in the natural state, an angle between the first reference line and the second reference line is 8°-25°.

5. The clip-on earphone of claim 3, wherein
when the clip-on earphone is in the natural state, an angle between the first reference line and the reference tangent is 50°-85°.

6. The clip-on earphone of claim 3, wherein
when the clip-on earphone is in the natural state, a length of the second reference line is 13-20 mm.

7. The clip-on earphone of claim 1, wherein
when the clip-on earphone is in the natural state, on the ear hook symmetry plane, the reference perpendicular has a first side and a second side arranged opposite to each other, and the sound production portion is located on the first side of the reference perpendicular; and
on the first side of the reference perpendicular, an inner contour line of the clip-on earphone has a fourth reference point farthest from the reference perpendicular, a distance between the fourth reference point and the reference perpendicular is denoted as a first distance, and the first distance is 4-9 mm.

8. The clip-on earphone of claim 7, wherein
when the clip-on earphone is in the natural state, on the second side of the reference perpendicular, the inner contour line of the clip-on earphone has a fifth reference point farthest from the reference perpendicular, a distance between the fifth reference point and the reference perpendicular is denoted as a second distance, and the second distance is 7-13 mm.

9. The clip-on earphone of claim 8, wherein
when the clip-on earphone is in the natural state, on the ear hook symmetry plane, an arc-to-chord ratio of the inner contour line of the clip-on earphone between the first reference point and the fourth reference point is 1.08-1.20.

10. The clip-on earphone of claim 1, wherein
when the clip-on earphone is in the natural state, on the ear hook symmetry plane, the contour line of the abutment portion has a sixth reference point closest to the first reference point, and a length of a connecting line between the first reference point and the sixth reference point is 6-10 mm.

11. The clip-on earphone of claim 10, wherein
when the clip-on earphone is in the natural state, on the ear hook symmetry plane, an arc-to-chord ratio of the inner contour line of the clip-on earphone between the first reference point and the sixth reference point is 1.7-2.2.

12. The clip-on earphone of claim 1, wherein
the ear hook and the sound production portion are configured as two separate components, and a parting line exists at an assembly position therebetween; and
an outer contour line of the clip-on earphone has a seventh reference point farthest from the reference tangent, and the seventh reference point is located on the ear hook.

13. The clip-on earphone of claim 1, wherein
each section of the ear hook comprises a support rib and a flexible body wrapping the support rib; and
the outer contour line of the clip-on earphone has a seventh reference point farthest from the reference tangent, and the seventh reference point is located on the ear hook.

14. The clip-on earphone of claim 1, wherein
when the clip-on earphone is in the natural state, on the ear hook symmetry plane, an angle between a connecting line between two opposite ends of the ear hook and the reference tangent is less than or equal to 45°.

15. The clip-on earphone of claim 8, wherein
when the clip-on earphone is in the natural state, on the ear hook symmetry plane, an arc-to-chord ratio of the inner contour line of the clip-on earphone between the first reference point and the fifth reference point is 1.01-1.06.

16. The clip-on earphone of claim 13, wherein the support rib includes an elastic metal sheet or an elastic metal wire.

17. The clip-on earphone of claim 13, wherein the support rib includes a first end and a second end arranged opposite each other, wherein
the first end of the support rib is connected to the sound production portion; and
the second end of the support rib is connected to the abutment portion.

18. The clip-on earphone of claim 1, wherein when the clip-on earphone is in the natural state, on the ear hook symmetry plane, the sound production portion and the abutment portion are arranged at an interval.

19. The clip-on earphone of claim 1, wherein when the clip-on earphone is in the natural state, on the ear hook symmetry plane, the sound production portion and the abutment portion are at least partially in contact.

20. The clip-on earphone of claim 1, wherein
each section of the ear hook has elasticity; and
the outer contour line of the clip-on earphone has a seventh reference point farthest from the reference tangent, and the seventh reference point is located on the ear hook.
